(19) United States
(12) Patent Application Publication
(10) Pub. No.: US 2012/0199274 A1
(43) Pub. Date: Aug. 9, 2012

(54) REMOVABLE LABEL WITH A DOUBLE-LAYER ADHESIVE

(75) Inventors: Noel Mitchell, Wuppertal (DE); Kati Metsäjoki, Pirkkala (FI); Jouni Iiskola, Turku (FI)

(73) Assignee: UPM RAFLATAC OY, Tampere (FI)

(21) Appl. No.: 13/497,828

(22) PCT Filed: Sep. 27, 2010
(86) PCT No.: PCT/FI10/50745

§ 371 Date: Apr. 26, 2012

(30) Foreign Application Priority Data
Sep. 25, 2009 (US) 61245700

(51) Int. Cl. C09J 7/02; B32B 38/10; B32B 7/12; B32B 33/00; C09J 7/04; B32B 37/12; B32B 38/04

(52) U.S. Cl. 156/182; 156/703; 156/327; 428/354; 428/41.8

(57) ABSTRACT

The invention relates to a removable labels having a multilayer adhesive structure, wherein the first adhesive layer comprises a hot-melt adhesive or tackifier and the second adhesive layer comprises an acrylic pressure-sensitive adhesive. The invention also relates to a method for manufacturing such labels and to use of the labels for labelling of reusable containers.

### FIELD OF THE INVENTION

The present invention relates to removable self-adhesive laminates and labels made thereof. More specifically, the invention relates to an adhesive layer.

### BACKGROUND OF THE INVENTION

Self-adhesive labels, also called as pressure-sensitive adhesive (PSA) labels, are well known in the art. Typically these labels consist of a release liner and a face or facestock material which are laminated together with a pressure sensitive adhesive layer in between.

Subsequently labels are adhered to the surface of an item through an adhesive layer forming a bond when pressure is applied on the label at room temperature.

Wash-off labels are an important topic, for example, in beverage industry where the recycling or reuse of bottles has to be performed effectively, environmentally and economically. The removal of labels from the bottles or other containers needs to be done so that all these points of view are taken comprehensively into account in every phase of the process.

The wash off labels, known from prior art, have been based on paper materials, which may become easily disintegrated into the washing liquid. Another known approach, which is typically used in combination with the paper labels, has been to select adhesives which are soluble into the water based washing liquid and thus lead to the removal of the labels. Use of such adhesives requires that the label material allows the washing liquid to penetrate into the adhesive layer so that rapid loosening of the label is possible. Even if these approaches may facilitate quick and effective removal of the labels in the washing process without leaving markings or residues on the container, they may suffer from the major drawback that the washing liquid quickly becomes contaminated by the label material and/or the dissolved adhesive components.

One further known possibility aiming to alleviate the aforementioned washing liquid contamination problem is as follows: a release liner, for example a polyester film, is coated with silicone which is then further coated with a pressure-sensitive adhesive and dried under heat in an oven. This adhesive layer is then laminated further with a mono- or biaxially oriented heat-shrinkable polyester (PET) or polyvinylchloride film (PVC), in which case the adhesive preferentially transfers to the PVC or PET filmic surface. This construction may be further overlaminated with another reverse printed film, such as a polypropylene film. Under the typical, standard washing conditions of 80-85° C. in an alkaline solution containing between 1-4% caustic soda, the base PVC or PET heat-shrinkable plastic film of such a construction shrinks severely causing the whole label to curl allowing the caustic solution to affect the adhesive with the result that the adhesive and the label detaches from the bottle. The bottles in this case could be typically either glass or polyester. According to this approach, the primary effect causing the label to become removed from the container is due to the shrinking of the heat-shrinkable plastic film. The major deficiencies of these type constructions are that they are rather costly and in addition in some cases they are using films containing environmentally unfriendly PVC solutions.

### SUMMARY OF THE INVENTION

It is an object to provide label, which is easy to wash off. It is an object of the present invention to provide a laminated structure for wash-off labels used in labelling of reusable containers, such as glass and plastic bottles for the beverage industry or other reusable containers. It is an object of the present invention to provide a method for producing said laminated structures.

According to a first aspect of the present invention there is provided a label (3) comprising:
a facestock (2);
a first adhesive layer (4) against the facestock (2);
a second adhesive layer (8) adjoining the first adhesive layer (4),
   wherein the first adhesive layer (4) comprises a hot-melt adhesive or a tackifier, and the second adhesive layer (8) comprises an acrylic pressure-sensitive adhesive.

According to a second aspect of the present invention there is provided a method for producing a pressure-sensitive adhesive laminated structure (1, 3), the method comprising:
coating a facestock (2) with a first adhesive layer (4) comprising a hot-melt adhesive or a tackifier;
coating a release liner (6) with a second adhesive layer (8) comprising an acrylic adhesive layer;
laminating the first adhesive layer (4) and the second adhesive layer (8) together so as to form a laminated structure (1, 3).

According to a third aspect of the present invention there is provided a use of the label (3) for labelling recyclable or reusable items (7).

According to a fourth aspect of the present invention there is provided a method for removing a label (3) from a surface of an item (5), the label (3) comprising a facestock (2), a first adhesive layer (4) against the facestock (2), a second adhesive layer (8) adjoining the first adhesive layer (4), wherein the first adhesive layer (4) comprises a hot-melt adhesive or a tackifier and the second adhesive layer (8) comprises an acrylic pressure-sensitive adhesive,

the method comprising exposing the first first adhesive layer (4) and the second adhesive layer (8) to an alkaline washing liquid (9) at a temperature which is higher than or equal to 60° C., preferably in the range of 80-85° C.

According to a fifth aspect of the present invention there is provided a combination of an item (5) and a label (3), wherein the label (3) has been attached to a surface (7) of the item (5), the label comprising
a facestock (2);
a first adhesive layer (4) against the facestock (2);
a second adhesive layer (8) adjoining the first adhesive layer (4),
   wherein the first adhesive layer (4) comprises a hot-melt adhesive or a tackifier, and the second adhesive layer (8) comprises an acrylic pressure-sensitive adhesive.

Further embodiments of the invention are presented in the dependent claims.

A surface of the second adhesive layer may be attached to an item, e.g. to a glass bottle or a plastic bottle.

The label comprises a multilayer structure of an adhesive. Components from the first adhesive layer may migrate into the second adhesive layer when at least one of the adhesive layers is exposed to a washing liquid. The migration may cause swelling of the second adhesive layer, which facilitates removal of the label from the bottle.

The washing liquid may be e.g. an alkaline washing liquid. The temperature of the washing liquid may be e.g. higher than or equal to 60° C., preferably in the range of 80-85° C.

The label attached to the item is in contact with a contact area of the item.

The label may be a wash-off label, i.e. it may be easily removed from the item. In an embodiment, the contact area may be substantially free from adhesive residues after removal of the label even without additional mechanical brushing or washing with high-pressure jets.

In an embodiment, dissolved adhesive components do not significantly contaminate the washing liquid. Consequently, more labels may be removed by using the same amount of washing liquid.

The label has improved wash-off characteristics. Consequently, using the label on re-usable containers may be economical and environmentally friendly, when compared with a label which is difficult to remove.

Here a new and innovative solution for wash-off label is proposed being economical, environmentally friendly and having improved wash-off characteristics. The invention is based on using a novel double-layer adhesive in the wash-off label and tailoring these layers so that very good wash-off characteristics are achieved even without need to have any heat-shrinking plastic layers in the label to aid the removal of the label. In this sense the invention differs clearly from the prior art solutions that require the use of plastic materials having significant heat-shrinking properties and therefore the invention also avoids all environmental or other drawbacks related to such heat-shrinking materials. The removable labels of the present invention can be washed off of an item surface, such as glass or plastic bottles or aluminium cans for the beverage industry or other reusable or recyclable containers. The invention also relates to a method for producing said labels.

### BRIEF DESCRIPTION OF THE DRAWINGS

In the following examples, the embodiments of the invention will be described in more detail with reference to the appended drawings, in which

FIG. 1a shows, in a cross-sectional view, a laminated structure,

FIG. 1b shows, in a cross-sectional view, a laminated structure comprising die-cut labels,

FIG. 1c shows, in a cross-sectional view, separating a release liner from a label,

FIG. 1d shows, in a side view, a label attached to the surface of an item,

FIG. 2 shows, in a side view, steps for removing a label from an item,

FIG. 3a shows, in a side view, a label attached to the surface of an item,

FIG. 3b shows, in a cross-sectional view, exposing a label to a washing liquid,

FIG. 3c shows, in a cross-sectional view, swelling of a second adhesive layer caused by migration of a component from a first adhesive layer to a second adhesive layer, and

FIG. 3d shows, in a cross-sectional view, a label removed from the item.

### DETAILED DESCRIPTION

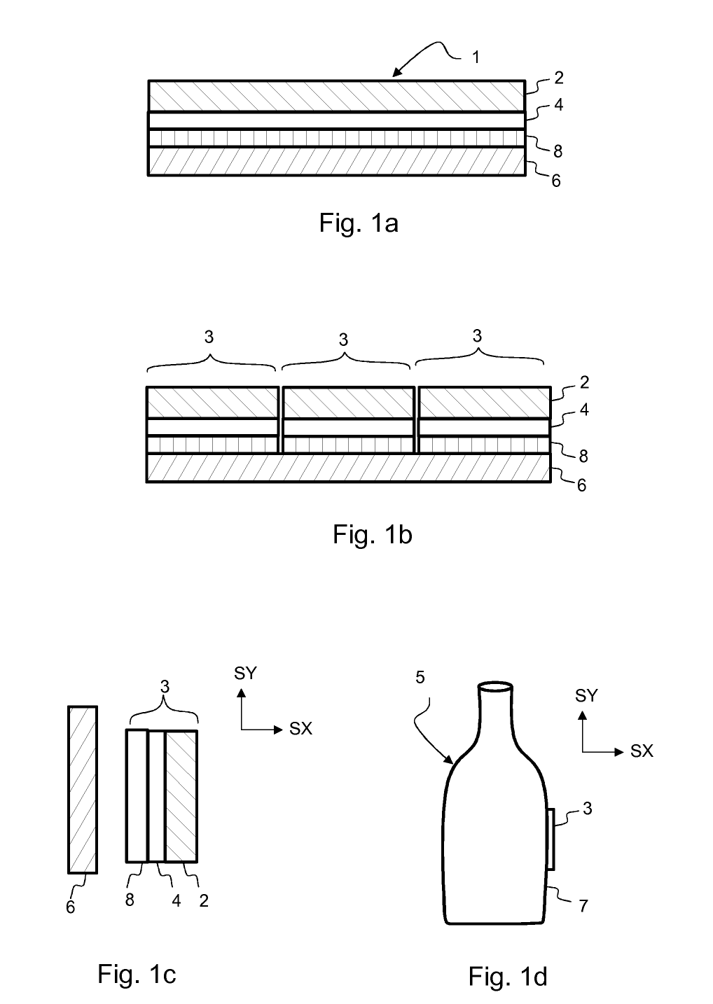

Referring to the FIG. 1a, a laminated structure 1 (laminated construction) may comprise a facestock 2, a first adhesive layer 4 against the facestock 2, a second adhesive layer 8 adjoining the first adhesive layer 4, and a release liner 6. The facestock 2 may also be called as a carrier layer or as a substrate. The facestock 2 (carrier layer) may be e.g. a paper sheet, cardboard, or a plastic film. The first adhesive layer 4 may comprise a hot-melt adhesive or a tackifier. A hot-melt adhesive may be 100% solid, thermoplastic material. The second adhesive layer 8 may comprise an acrylic adhesive. In particular, the second adhesive layer 8 may be a pressure sensitive adhesive layer comprising a water-based acrylic adhesive.

The liner 6 may be coated with silicon, i.e. there may be a thin layer of silicone polymer between the second adhesive layer 8 and the liner 6. The final structure of the laminate construction 1 may thus be the following (in the following order): facestock 2—hot melt adhesive 4—acrylic adhesive 8—release liner 6.

A method for producing the laminated structure may comprise:
heating a hot-melt adhesive and covering the facestock 2 with a layer of substantially molten (softened) hot-melt adhesive 4,
cooling the hot-melt layer 4,
covering the release liner 6 with a layer of pressure sensitive adhesive layer 8, such as the water based acrylic adhesive, and
laminating the hot-melt adhesive layer 4 and the pressure sensitive adhesive layer 8 together.

The method may further comprise covering the release liner 6 with a silicone polymer prior to covering the release liner 6 with the hot-melt adhesive.

The hot-melt layer may be applied on the facestock e.g. by using slot-die- or roller-coaters. The temperature of the hot-melt layer 4 may be e.g. in the range of 150 to 180° C.

An acrylic dispersion may be applied on the release liner 6 e.g. by using curtain coating or reverse gravure. Water may be evaporated from the dispersion by using e.g. hot air jets or infra-red heaters. The temperature of the layer 8 may be e.g. in the range of 70 to 90° C. during the evaporation (drying).

Consequently, two webs may be formed. The first web comprises the facestock 2 and the first adhesive layer 4. The second web comprises the release liner 6 and the second adhesive layer 8. The two adhesive-containing webs may be laminated together in a nip, thereby producing a self-adhesive laminate structure 1. The laminate structure has a two-layer adhesive structure in the middle.

The laminate construction 1 or a label 3 may further comprise additives like fillers. The laminate construction 1 or the label 3 may further comprise additional layers, such as sublayers. The laminate construction 1 or the label 3 may further comprise further adhesive or face material layers, print layers, functional or protective layers, in order to improve the label properties, functionality or appearance. Graphical patterns may be printed on the facestock 2 e.g. in order to provide a visual effect and/or in order to display information.

Referring to FIG. 1b, individual labels 3 may be cut from the laminate structure 1. In particular, the labels 3 may be die-cut from the structure 1. After cutting, the labels may be attached to a common liner 6 (liner remains uncut). Thus, a plurality of labels may remain attached to a common continuous liner 6. Alternatively, the labels 3 may be completely separate (i.e. also the liner 6 may be cut).

Referring to FIG. 1c, the label 3 may be separated from the liner 6 e.g. by pulling the label in the direction SX with respect to the liner 6. Thus, a surface the second adhesive layer 8 may be exposed so that said surface can be attached to an item 5. The second adhesive layer 8 may be in direct contact with the surface 7 of the item 5. FIG. 1d shows a label 3 attached to the surface of an item 5 such as bottle.

The label 3 may be pressure-sensitive adhesive (PSA) label.

The combination of the first adhesive layer 4 and the second adhesive layer 8 may be called as an adhesive double layer 10. The double layer 10 may comprise a hot-melt layer 4 and an acrylic layer 8.

The acrylic layer 8 may be in contact with the surface 7 of the item 5. The acrylic layer 8 may be removed cleanly from the surface 7 during the wash-off process so that it will not significantly stain or leave deposits on the surface 7. The acrylic adhesive can be selected in order to have optimized clean removal from the items 5 in the wash-off process.

The hot-melt or tackifier layer 4 is not in contact with the surface 7. Thus, removal of hot-melt or tackifier from the surface 7 may be avoided. The adhesion of the hot-melt adhesive to the glass bottles can be very high leading to very poor wash-off characteristics. Furthermore, additional components, such as tackifiers, may migrate from the hot-melt adhesive layer towards the surface 7. The additional components may stain especially plastic bottles, leaving so called “ghosting” marks on the bottle. The additional components may leave tacky adhesive residues on the bottle rendering them unsuitable for re-use. According to the invention, the hot-melt/tackifier will not be in contact with the item 5. Thus, the above-mentioned problems may be substantially avoided.

The composition of the first adhesive layer 4 may be selected so as to substantially eliminate harmful effects like staining or instability of the facestock 2, which could be caused by the migration of species from the hot-melt layer into the facestock material. The hot-melt adhesive and the type of facestock may be selected such that negative interaction (migration) between these two layers may be substantially avoided. When the materials of the facestock 2 and the first adhesive layer 4 are selected in this way, there is no need to use an acrylic or any other barrier layer in between the facestock 2 and the first adhesive layer 4.

The first adhesive layer 4 may comprise a hot-melt adhesive which may include, but is not limited to, styrenic polymers such as styrene block-copolymers also referred to as block-copolymer rubbers, for example styrene-isoprene-styrene and styrene-butadiene. The hot-melt adhesive may also include, but is not limited to, hydrocarbon resins and/or rosin esters, which may also be referred to as tackifiers.

During manufacturing of the label laminate structure 1, premixing the components of the hot-melt adhesive with the aqueous acrylic adhesive may be difficult in the liquid state before application of the layers, as these adhesive components are inherently immiscible with one another. In other words, the hot-melt adhesive and the aqueous acrylic adhesive cannot be premixed to become a single adhesive mixture.

Therefore, a form of solid-state mixing taking place only after the separate application of these individual adhesive layers on the facestock and on the release liner, respectively, is the only viable option in this case as because these two adhesives need to be applied in different physical forms (water dispersion vs. hot-melt). In that format they cannot become mixed.

However, there can be some mixing between the hot-melt adhesive and the aqueous acrylic adhesive after the layers 4 and 8 have been laminated together.

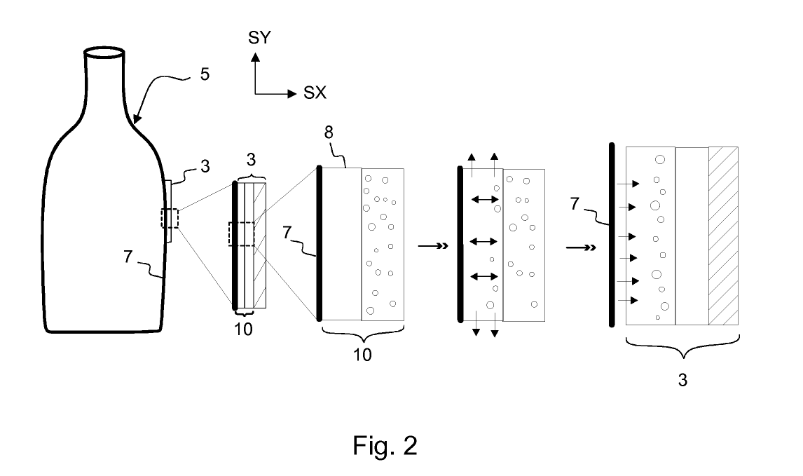

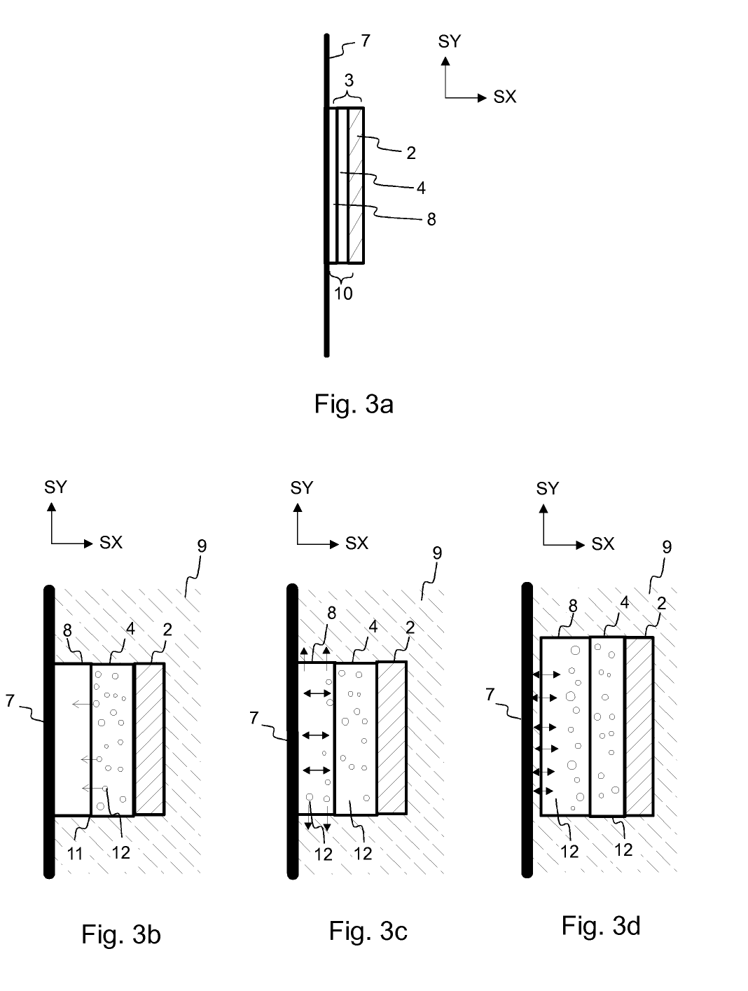

FIG. 2 shows several steps for removing a label 3 from the surface 7 of an item 5. The individual steps are discussed in detail with reference to FIGS. 3a-3d.

FIG. 3a shows a label 3 attached to the surface 7 of the item 5. The label 3 comprises the double layer 10 and the facestock 2. The double layer 10 comprises the first adhesive layer 4 and the second adhesive layer 8. The whole area of the second adhesive layer 8 may be initially in contact with the surface 7. Initially, there is not gap between the second layer 8 and the surface 7, and a washing liquid 9 cannot directly penetrate between the second layer 8 and the surface 7.

Referring to FIG. 3b, the label and more precisely the multilayer adhesive construction 10 (double layer 10) comprising the first adhesive layer 4 and the second adhesive layer 8 may behave in the following way. When the first adhesive layer 4 and the second adhesive layer 8 are exposed to a washing liquid, one or more components of the hot-melt layer 4, in particular tackifiers 12 may migrate into the second adhesive layer 4 through the interface 11 between the first layer 4 and the second layer 8. In other words, a tackifier and/or other migrating component moves from the first layer 4 to the second layer 8. Migrating components may include solid tackifiers, liquid resins and/or oils. The migrating component may include an oil and/or liquid resin.

It is not necessary that 100% of the component(s) is migrated from the first adhesive layer 4 to the second adhesive layer 8. The amount may be substantially smaller than 100%, e.g. 2-30%.

The washing liquid 9 may be e.g. an alkaline water solution. The solution may contain e.g. 0.5-10% caustic soda, in particular 1-4% caustic soda (by weight).

The temperature of the washing liquid 9 may be e.g. higher than or equal to 60° C., preferably in the range of 80-85° C.

The removal of the label 3 from the surface 7 may comprise exposing the adhesive multilayer structure 10 to heated washing liquid 9.

At least one of the first adhesive layer 4 and the second adhesive layer 8 may be exposed to the washing liquid 9. The first adhesive layer 4 may be exposed to the liquid 9. The second adhesive layer 8 may be exposed to the liquid 9. Both adhesive layers 4 and 8 may be exposed to the liquid 8. The edges of one of the first adhesive layer 4 and the second adhesive layer 8 may be exposed to the washing liquid 9. At a later stage of the removal process, the washing liquid may penetrate into the first adhesive layer 4 through the second adhesive layer 8. In an embodiment, the washing liquid may penetrate into the first adhesive layer 4 through the facestock 2.

First, the washing liquid may penetrate through the edges of the label 3 into the adhesive layers 4, 8. The migration of components through the interface 11 of the first layer 4 and the second layer may appear at least at the peripheral surfaces or edges of the label 3 which are in direct contact with the washing liquid 9.

With reference to FIG. 3c the migration of tackifiers or other components of the hot melt adhesive may cause swelling of the acrylic adhesive layer 8.

The second layer 8 may swell, i.e. expand, in the direction SX and/or in the direction SY. The second layer 8 may at least partially lose contact with the surface 7, due to the swelling.

Referring to FIG. 3d, a small gap may be formed between the second adhesive layer 8 and the surface 7 of the item 5. The hot washing liquid 9 may rapidly penetrate into gap. Thus, the swelling makes it easy for the washing liquid 9 to deactivate and/or deaden the adhesive of the contact surface of the second layer 8. The second layer 8 may subsequently lose the adhesive force, and the label 3 may be easily peeled away from the surface 7.

In an embodiment, dissolved adhesive components and/or disintegrated paper material do not significantly contaminate the washing liquid. Consequently, more labels may be removed by using the same amount of washing liquid. The facestock may comprise e.g. an alkali-resistant wet strength paper, which does not substantially disintegrate.

The thermal expansion coefficient of the first adhesive layer 4 may be substantially different from the thermal expansion coefficient of the second adhesive layer 8. This may cause a force which pulls the label 3 locally away from the surface 7. Thus, the difference in the thermal expansion coefficients may cause unevenness in the adhesive layer and swelling which assists the wash-off mechanism described above in the washing conditions.

The laminate construction 1 for labels 3 described above, with the acrylic adhesive layer next to the release liner 6, may also provide a structure which has excellent die-cutting properties, when compared with a structure which has a hot-melt adhesive layer adjoining a release liner.

In a comparative case a hot-melt layer would be applied onto the release liner, and an acrylic adhesive layer would be applied onto the hot melt layer. However, this kind of a method would require a complicated and expensive dual-layer coating system. In dual-layer coating there may arise problems such as softening and bleeding of the underneath adhesive layer. In addition if the facestock is dual-layer coated with said adhesive layers there may occur unwanted deformation of the facestock.

Furthermore, it is not practical in industrial scale to coat an aqueous acrylic adhesive at high speed directly onto the facestock and dry it at elevated temperature and apply the hot-melt to the release-liner and then combine them, because in this case the drying of the acrylic adhesive on very thin filmic (plastic) facestocks would deform and cause shrinkage of such films.

The expensive and complicated dual-layer coating system may be avoided when forming the layers 4, 8 separately on the liner 6 and on the facestock 2, and when laminating the formed webs together.

It has been noticed that the label laminate structures 1 according to the invention have good die-cutting properties. The wash-off properties of the labels 3 according to the invention comply with industrial requirements. In a solution of 1.5% caustic soda at 80° C., the wash-off times of labels 3 has been observed to be in the range of 60 to 120 seconds. These wash-off times are acceptable in industrial conditions.

It is known that a heat-shrinking plastic layer may facilitate removal of a label 3 from the surface 7 of an item 5. In an embodiment, the label 3 does not comprise a heat-shrinking plastic layer. Consequently, environmental or other drawbacks related to the sue of heat-shrinking materials may be avoided.

Advantageously label 3 does not comprise heat-shrinkable materials whose heat-shrinkability is greater than 5% at temperatures between 65 to 90° C. Advantageously all materials of the label have heat-shrinkability substantially less 5%. Heat-shrinkability means a dimensional change of a material in at least one direction when the temperature of the material is increased from 25 to 90° C.

The label is easily removed from the surface 7 of an item 5. The item 5 may be e.g. a glass bottle, a plastic bottle, an aluminium can containing a beverage, a reusable container, or recyclable containers. The item 5 may be polyester bottle or polyester container.

In an embodiment, the facestock of the label may be either plastic film or paper. In an embodiment, the label comprises a release-liner, which in turn may be either plastic film or paper. Advantageously, the first adhesive layer of the label does not significantly interfere with the facestock material, i.e. components of the first adhesive layer should not migrate into the facestock material in the dry state so that the visual appearance and/or composition of the facestock would be changed.

The double-layer adhesive structure may be used together with economical and environmentally friendly non-shrinking film materials.

The facestock 2 may comprise an environmentally friendly polyolefin film which is non-shrinkable. The term “non-shrinkable” means that the plastic film for the facestock is not heat-shrinkable i.e. not shrinkable at elevated temperatures and has an average dimensional change substantially less than 5% at temperatures between 65 to 90° C., even in wet conditions

Non-shrinkable polyolefin films for facestock may include e.g. biaxially oriented plastic films, such as polypropylene (BOPP). These biaxially oriented plastic films are oriented in two perpendicular directions: in a machine direction (MD, direction of the movement of a web) and in a transverse direction (TD, perpendicular to a direction of movement of the web). The biaxial orientation may be done through a tentering frame process which creates different degrees of orientation in the MD and CD directions. The degree of orientation may be for example approximately equal to 9 in CD, and approximately equal to and 5.5 in MD. The films may also be oriented by using so called double bubble tubular stretching process which produces similar degrees of orientation in both the MD and TD directions. The degrees of orientation may be for example approximately equal to 7.

According to an advantageous embodiment of the invention, the facestock has biaxially oriented structure with different levels of orientation in TD and MD directions. This kind of oriented structure may be beneficial in further assisting the removal of the label during washing process allowing faster removal and shorter washing times. According to another embodiment of the invention, the facestock is a paper material.

If desired, the double layer adhesive structure may also be combined with plastic film materials having minor or more pronounced heat-shrinkability. For example, the facestock 2 may comprise a mono- or biaxially oriented heat-shrinkable polyester (PET) or polyvinylchloride film (PVC). The facestock 2 may comprise a polypropylene film. However, non-heat shrinkable films are typically more environmentally friendly than heat-shrinkable films.

The various aspects of the invention are illustrated by the following examples.

### Example 1.1

A multi-layer adhesive construction comprising: a facestock, a hot-melt or tackifier-containing layer and an acrylic pressure-sensitive layer and a release-liner.

### Example 1.2

The construction according to example 1.1, wherein the facestock is either plastic film or paper.

### Example 1.3

The construction according to example 1.1, wherein the release-liner is either plastic film or paper.

### Example 1.4

The construction according to example 1.1, wherein the hot-melt tackifier-containing layer is against the facestock, which adjoins the layer of acrylic pressure-sensitive adhesive which is further against the release-liner.

### Example 1.5

The construction according to example 1.1, wherein the hot-melt or tackifier-containing layer is selected to have a composition that will not interfere with the facestock material.

### Example 1.6

The construction according to example 1.1, wherein the hot-melt or tackifier-containing layer is selected to have a composition that will cause migration of species between said layer and the acrylic-pressure sensitive layer in wash off conditions.

### Example 1.7

A method of producing adhesive construction wherein a facestock is coated with the hot-melt compound layer, a release-liner is coated with an acrylic adhesive layer and after that said two layers are laminated together, forming a pressure-sensitive adhesive construction.

### Example 1.8

The use of the construction according to examples 1.1-1.4 for pressure-sensitive labels.

### Example 1.9

The use of the construction according to examples 1.1-1.4 for labelling containers.

### Example 1.10

The use of the construction according to examples 1.1-1.4 for wash off labels.

### Example 2.1

A label (3) comprising:
a facestock (2);
a first adhesive layer (4) against the facestock (2);
a second adhesive layer (8) adjoining the first adhesive layer (4), wherein the first adhesive layer (4) comprises a hot-melt adhesive or a tackifier, and the second adhesive layer (8) comprises an acrylic pressure-sensitive adhesive.

### Example 2.2

The label according to example 2.1, wherein the facestock (2) comprises plastic film and/or paper.

### Example 2.3

The label according to example 2.1, further comprising a release-liner (6) comprises plastic film and/or paper

### Example 2.4

The label according to any of the examples 2.1 to 2.3, wherein a surface of the second adhesive layer (8) is capable of adhering to an item (5).

### Example 2.5

The label according to any of the examples 2.1 to 2.4, wherein a material of the facestock (2) and a material of the first adhesive layer (4) have been selected such that the material of the first adhesive layer (4) does not interfere with the material of the facestock (2).

### Example 2.6

The label according to any of the examples 2.1 to 2.5, wherein at least one component (12) of the first adhesive layer (4) is arranged to migrate into the second adhesive layer (8) so as to cause swelling of the second adhesive layer (8) when the first adhesive layer (4) is exposed to a washing liquid (9).

### Example 2.7

A method for producing a pressure-sensitive adhesive laminated structure (1, 3), the method comprising:
coating a facestock (2) with a first adhesive layer (4) comprising a hot-melt adhesive or a tackifier;
coating a release liner (6) with a second adhesive layer (8) comprising an acrylic adhesive layer;
laminating the first adhesive layer (4) and the second adhesive layer (8) together so as to form a laminated structure (1, 3).

### Example 2.8

The method of example 2.7 further comprising cutting the laminated structure (1, 3) so as to form labels (3).

### Example 2.9

A use of the label (3) according to any of the examples 2.1-2.7 for labelling recyclable or reusable items (7).

### Example 2.10

A method for removing a label (3) from a surface of an item (5), the label (3) comprising a facestock (2), a first adhesive layer (4) against the facestock (2), a second adhesive layer (8) adjoining the first adhesive layer (4), wherein the first adhesive layer (4) comprises a hot-melt adhesive or a tackifier and the second adhesive layer (8) comprises an acrylic pressure-sensitive adhesive,

the method comprising exposing the first first adhesive layer (4) and the second adhesive layer (8) to an alkaline washing liquid (9) at a temperature which is higher than or equal to 60° C., preferably in the range of 80-85° C.

### Example 2.11

A combination of an item (5) and a label (3), wherein the label (3) has been attached to a surface (7) of the item (5), the label comprising
a facestock (2);
a first adhesive layer (4) against the facestock (2);
a second adhesive layer (8) adjoining the first adhesive layer (4),
   wherein the first adhesive layer (4) comprises a hot-melt adhesive or a tackifier, and the second adhesive layer (8) comprises an acrylic pressure-sensitive adhesive.

### Example 2.12

A combination according to example 2.11, wherein the item (5) is a recyclable or reusable container selected from a group consisting of a glass bottle, a plastic bottle, a plastic container, and a glass container.

For the person skilled in the art, it will be clear that modifications and variations of the devices and the methods according to the present invention are perceivable. The drawings are schematic. The particular embodiments described above with reference to the accompanying drawings are illustrative only and not meant to limit the scope of the invention, which is defined by the appended claims.

1. A label comprising:
a facestock;
a first adhesive layer against the facestock;
a second adhesive layer adjoining the first adhesive layer,
wherein the first adhesive layer comprises a hot-melt adhesive and/or a tackifier, and the second adhesive layer comprises an acrylic pressure-sensitive adhesive such that at least one component of the first adhesive layer is arranged to migrate into the second adhesive layer so as to cause swelling of the second adhesive layer when the first adhesive layer is exposed to a washing liquid so that the label is removable from the surface of an item attached.

2. The label according to claim 1, wherein the facestock comprises plastic film and/or paper.

3. The label according to claim 1, further comprising a release-liner including plastic film and/or paper.

4. The label according to claim 1, wherein a surface of the second adhesive layer is capable of adhering to an item.

5. The label according to claim 1, wherein a material of the facestock and a material of the first adhesive layer have been selected such that the material of the first adhesive layer does not interfere with the material of the facestock.

6. A method for producing a pressure-sensitive adhesive laminated structure wherein at least one component of the first adhesive layer is arranged to migrate into the second adhesive layer so as to cause swelling of the second adhesive layer when the first adhesive layer is exposed to a washing liquid the method comprising:
coating a facestock with a first adhesive layer comprising a hot-melt adhesive or a tackifier;
coating a release liner with a second adhesive layer comprising an acrylic adhesive layer;
laminating the first adhesive layer and the second adhesive layer together so as to form a laminated structure.

7. The method of claim 6 further comprising cutting the laminated structure so as to form labels.

8. A use of the label according to claim 1 for labelling recyclable or reusable items.

9. A method for removing a label from a surface of an item the label comprising a facestock a first adhesive layer against the facestock a second adhesive layer adjoining the first adhesive layer, wherein the first adhesive layer comprises a hot-melt adhesive or a tackifier and the second adhesive layer comprises an acrylic pressure-sensitive adhesive such that at least one component of the first adhesive layer is arranged to migrate into the second adhesive layer so as to cause swelling of the second adhesive layer when the first adhesive layer is exposed to a washing liquid
the method comprising exposing at least one of the first first adhesive layer and the second adhesive layer to an alkaline washing liquid at a temperature which is higher than or equal to 60° C., preferably in the range of 80-85° C.

10. A combination of an item and a label wherein the label has been attached to a surface of the item the label comprising
a facestock
a first adhesive layer against the facestock
a second adhesive layer adjoining the first adhesive layer
wherein the first adhesive layer comprises a hot-melt adhesive or a tackifier, and the second adhesive layer comprises an acrylic pressure-sensitive adhesive such that at least one component of the first adhesive layer is arranged to migrate into the second adhesive layer so as to cause swelling of the second adhesive layer when the first adhesive layer is exposed to a washing liquid.

11. A combination according to claim 10, wherein the item is a recyclable or reusable container selected from a group consisting of a glass bottle, a plastic bottle, a plastic container, and a glass container.
